(19) United States
(12) Patent Application Publication
(10) Pub. No.: US 2009/0172522 A1
(43) Pub. Date: Jul. 2, 2009

(54) Text Composition

(76) Inventor: Fumiko Ichikawa, Tokyo (JP)

Correspondence Address: WARE FRESSOLA VAN DER SLUYS & ADOLPHSON, LLP, BRADFORD GREEN, BUILDING 5, 755 MAIN STREET, P O BOX 224, MONROE, CT, 06468, US

(21) Appl. No.: 12/086,730

(22) PCT Filed: Dec. 24, 2005
(86) PCT No.: PCT/IB2005/004057

§ 371 Date: Oct. 23, 2008

(51) Int. Cl. G06F 17/21

(52) U.S. Cl. 715/256

(57) ABSTRACT

A method of text composition comprising: displaying a string of characters as text, the text comprising an arrangement of graphical symbols wherein each of the graphical symbols corresponds to a character in the string; and controlling the visual attributes of the displayed text such that at least the graphical symbol corresponding to a final character in the string has a first visual attribute that differentiates it from the other graphical symbols in the displayed text that have a second visual attribute.

### CROSS REFERENCE TO RELATED APPLICATIONS

This application is the U.S. National Stage of International Application Number PCT/IB2005/004057 filed on Dec. 24, 2005 which was published in English on Jul. 5, 2007 under International Publication Number WO 2007/074353.

### FIELD OF THE INVENTION

Embodiments of the present invention relate to text composition using an electronic device.

### BACKGROUND TO THE INVENTION

For some languages, the order in which characters are displayed as text is the same as the order in which the characters are entered. For these languages it is a simple matter during text composition using an electronic device to identify and select the last entered character or a series of recently entered characters or to identify where the next character is to be entered.

For example, an empty space and an I-blink cursor is typically used to indicate to a user where the current insertion point is for text. Highlighting may be used when a user selects multiple characters. Typically a rectangle covers the selected multiple characters and the color of the background for the rectangle and characters is the inversion of that used for the background and characters outside the rectangle.

If auto-completion of words is used, it is also a simple matter to identify the characters that have been explicitly entered by a user and those characters that have been suggested by the auto-completion software. This enables a user to either accept the suggested word or to continue with the explicit entry of additional characters. Typically, the characters that have been explicitly entered are underlined whereas those that are suggested are not.

However, there are at present no simple solutions for languages in which characters may be displayed as text in a different order to that in which the characters are entered by a user or for languages in which the text is displayed as an arrangement of graphical symbols and entering a character may adapt the appearance of an existing graphical symbol.

### SUMMARY OF THE INVENTION

According to one embodiment of the invention there is provided a method of text composition comprising: displaying a string of characters as text, the text comprising an arrangement of graphical symbols wherein each of the graphical symbols corresponds to a character in the string; and controlling the visual attributes of the displayed text such that at least the graphical symbol corresponding to a final character in the string has a first visual attribute that differentiates it from the other graphical symbols in the displayed text that have a second visual attribute.

According to one embodiment of the invention there is provided a computer program comprising computer program instructions which when loaded into a processor enables the processor to control the visual attributes of displayed text such that at least a graphical symbol, corresponding to a character in a text string that is adjacent an insertion point, has a first visual attribute that differentiates it from other graphical symbols corresponding to other characters in the text string that have a second visual attribute.

According to one embodiment of the invention there is provided an electronic device comprising: a user input for specifying characters in a string of characters; a display for displaying the string of characters as text, the text comprising an arrangement of graphical symbols wherein each of the graphical symbols corresponds to a character in the string of characters; a processor for controlling the visual attributes of displayed text such that at least a graphical symbol corresponding to a character, adjacent an insertion point, in a string of characters has a first visual attribute that differentiates it from other graphical symbols corresponding to other characters in the string of characters that have a second visual attribute.

Embodiments of the invention enable a user to identify the latest characters in a text composition from the arrangement of graphical symbols. This also identifies where a next character is to be entered.

### BRIEF DESCRIPTION OF THE DRAWINGS

For a better understanding of the present invention reference will now be made by way of example only to the accompanying drawings in which:

FIG. 1 schematically illustrates an electronic device programmed for carrying out an embodiment of the invention; and

FIG. 2 illustrates a method of text composition according to an embodiment of the invention.

FIGS. 3A and 3B illustrate text in which the most recently entered graphical symbol has a different visual attribute than the other graphical symbols of the arrangement; and

FIG. 4, illustrates how a consonant sound can be modified by a vowel in Devanagari script.

### DETAILED DESCRIPTION OF EMBODIMENTS OF THE INVENTION

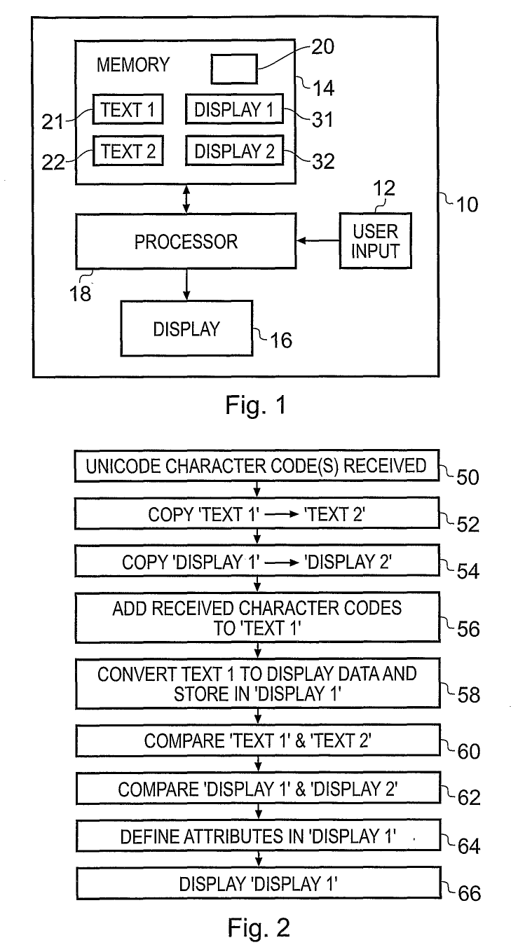

FIG. 1 schematically illustrates an electronic device 10 that is suitable for composing text. Only the features referred to in the following description are illustrated. It should, however, be understood that the device 10 may comprise additional features that are not illustrated. The electronic device 10 may be, for example, a personal computer, a personal digital assistant, a mobile cellular telephone, a word processor or any other electronic device that enables text composition.

The illustrated electronic device 10 comprises: a user input 12, a memory 14, a display 16 and a processor 18. The processor 18 is connected to receive input commands from the user input 12 and to provide output commands to the display 16. The processor 18 is also connected to write to and read from the memory 14.

The user input 12 is used for entering a sequence of characters during text composition.

The memory 14 provides a first text buffer 21, a second text buffer 22, a first display buffer 31 and a second display buffer 32. A text buffer stores a sequence of Unicode character codes that corresponds to the sequence of characters rendered on the display 16. A display buffer stores data for controlling the image presented by the display 16.

The memory 14 also stores computer program instructions 20, which when loaded into the processor 18, enable the processor 18 to control the operation of the device 10. The computer program instructions 20 provide the logic and routines that enables the electronic device 10 to perform the method illustrated in FIG. 2.

The computer program instructions 20 may arrive at the electronic device 10 via an electromagnetic carrier signal or be copied from a physical entity such as a computer program product, a memory device or a record medium such as a CD-ROM or DVD.

FIG. 2 illustrates a method of text composition.

At step 50, a series of one or more character code(s) is received at the processor 18. A single character code may be received, for example, in response to a user specifying, via the user input 12, a last character in a string of characters. Multiple character codes may be received, for example, if auto text completion software determines that the string of characters already input by a user can be completed by one or more additional characters. The multiple character codes received correspond to the additional characters determined by the auto-completion software.

At step 52, the current content of the first text buffer 21 is copied to the second text buffer 22.

At step 54, the current content of the first display buffer 31 is copied to the second display buffer 22.

At step 56, the received character code(s) is/are added to the first text buffer 21. Typically the received character code(s) is/are added to the end of the first text buffer 21.

At step 58, the content of the first text buffer 21 is converted to display data and stored in the first display buffer 31. The display data in the first display buffer 31 will be used to display an arrangement of graphical symbols. Each of the graphical symbols corresponds to a character code in the first text buffer 21.

At step 60, the content of the text buffers 21, 22 is compared. The character code(s) within the first text buffer 21 that is/are not in the second text buffer 22 are flagged. This identifies the most recently added character code(s) and may be useful if multiple characters are entered into the first text buffer or if characters are entered into the first text buffer 21 other than in a time sequential order.

At step 62, the content of the display buffers 31, 32 is compared. The graphical symbol(s) defined by the display data in the first display buffer 31 that is/are not defined by the display data in the second display buffer 32 are flagged.

At step 64, display data in the first display buffer 31 that has been flagged is modified so that the graphical symbol (s) defined by the flagged display data has a first visual attribute that is different to a second visual attribute used for the other graphical symbols of the arrangement of graphical symbols. The first visual attribute differentiates the graphical symbol(s) defined by the flagged display data from the other graphical symbols in the arrangement. For example, the first visual attribute may be characterized by any one or more of: bolder font, different color, blinking, etc.

At step 66, the display data in the first display buffer 31 is used to control the display. The display displays text as an arrangement of graphical symbols. Each of the graphical symbols corresponds to a character code in the first text buffer 21. The graphical symbols that correspond to the character code(s) received in step 50 have a different visual attribute to the other graphical symbols.

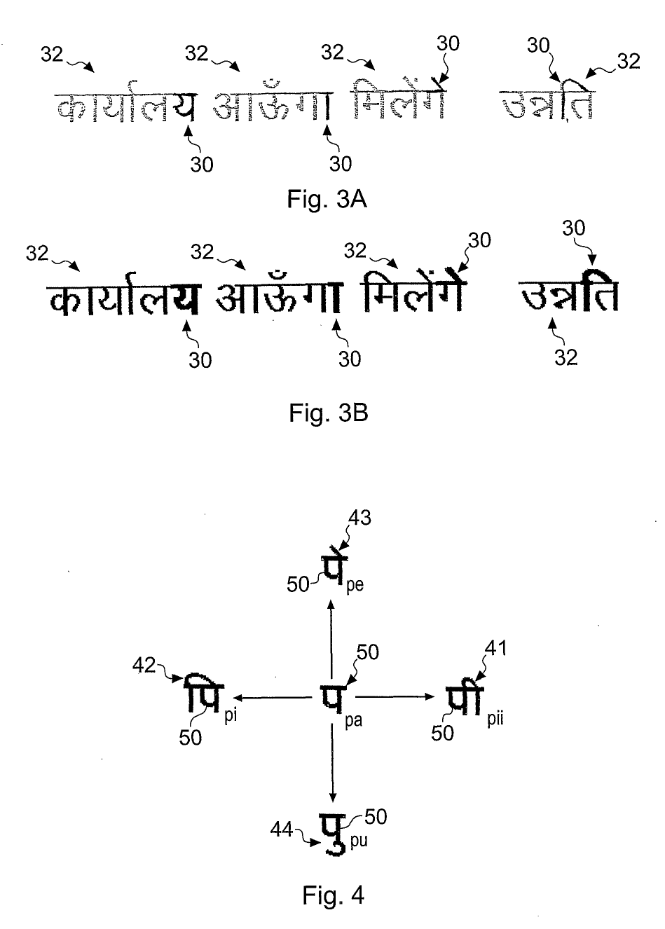

FIG. 3A illustrates four different examples of displayed text. In FIG. 3A the most recently entered graphical symbol 30 has a different color (grayscale in the Fig) than the other graphical symbols in the arrangement 32.

FIG. 3B illustrates four different examples of displayed text. In FIG. 3B the most recently entered graphical symbol 30 has a bolder font than the other graphical symbols in the arrangement 32.

It is consequently a simple matter for a user to identify the graphic symbol(s) that have been most recently added to the arrangement of graphic symbols.

The user may select a deletion option to delete the graphic symbols that have the first visual attribute. The deletion may be carried out by copying the content of the second text buffer 22 to the first text buffer 21 and copying the content of the second display buffer 32 to the first display buffer 31.

The user may edit the graphic symbols having the first visual attribute. The editing is carried out by replacing the flagged character codes in the first text buffer 21 with new character codes.

Devanagari script, used in languages like Hindi or Marathi, comprises consonants and vowels. Each consonant is displayed as a graphical symbol and has a sound, such as ka, ta, pa, etc. As illustrated in FIG. 4, in order to modify a consonant sound a vowel is depended from the consonant. Each vowel has a different graphical symbol 41, 42, 43, 44 which is placed as an extension to the consonant graphical symbol 50 on its right, left, top, or bottom. The consonant vowel combination is represented as a composite graphical symbol. The composite graphical symbol comprises a graphical symbol corresponding to a consonant character that forms a core. The core is extended by the graphical symbol for the vowel.

When a user enters the vowel character, the graphical symbol corresponding to the vowel character has the first visual attribute whereas the core graphical symbol corresponding to the consonant character has the second visual attribute. The user may therefore edit the graphic symbol corresponding to the vowel independently of the graphic symbol corresponding to the consonant.

Other languages also use arrangements of graphical symbols where each graphical symbol corresponds to a character in a word. For example, That, Lao, Khmer and Burmese script have a vowel sign or tone marks attached to the lower/upper part of the consonant. Indic scripts have a consonant core with extensions such as REPHA and MATRA. Vietnamese script uses accented characters and tone marks.

The foregoing description describes an application in which the graphical symbol corresponding to the most recently input character is highlighted. This is particularly useful when the order in which graphical symbols are displayed does not necessarily correspond with the order in which characters are entered.

The invention also finds application when the current insertion point is moved within a character string. If the character string comprises characters [c₀ . . . cᵢ] and the character insertion point is moved to i=N so that it is before character c_{N}, then the character string [c₀ . . . c_{N-1}] is converted to display data DD_{N-1} for displaying an arrangement A_{N-1} of graphical symbols and the character string A_{N-1} is converted to display data DD_{N-2} for displaying an arrangement A_{N-2} of graphical symbols. The display data DD_{N-1} and DD_{N-2} are compared and the display data for the graphical symbol(s) defined by the display data DD_{N-1} that is/are not defined by the display data DD_{N-2} are flagged. The display data in the first display buffer 31 that has been flagged is modified so that the graphical symbol(s) defined by the flagged display data has a first visual attribute that is different to a second visual attribute used for the other graphical symbols of the arrangement of graphical symbols. The first visual attribute differentiates the graphical symbol(s) defined by the flagged display data from the other graphical symbols in the arrangement. For example, the first visual attribute may be characterized by any one or more of: bolder font, different color, blinking, etc.

Although embodiments of the present invention have been described in the preceding paragraphs with reference to various examples, it should be appreciated that modifications to the examples given can be made without departing from the scope of the invention as claimed.

Whilst endeavoring in the foregoing specification to draw attention to those features of the invention believed to be of particular importance it should be understood that the Applicant claims protection in respect of any patentable feature or combination of features hereinbefore referred to and/or shown in the drawings whether or not particular emphasis has been placed thereon.

What is claimed is:

1. A method comprising:
displaying a string of characters as text, the text comprising an arrangement of graphical symbols wherein each of the graphical symbols corresponds to a character in the string; and
controlling the visual attributes of the displayed text such that at least the graphical symbol corresponding to a final character in the string has a first visual attribute that differentiates it from the other graphical symbols in the displayed text that have a second visual attribute.

2. The method as claimed in claim 1, wherein a sequential order of the characters within the string of characters does not correspond to an order of the graphical symbols within the arrangement of graphical symbols.

3. The method as claimed in claim 1, wherein the string of characters is terminated by a current text insertion point adjacent the final character.

4. The method as claimed in claim 3, wherein moving the text insertion point changes the string of characters.

5. The method as claimed in claim 3, wherein the string of characters is an initial portion of a word.

6. The method as claimed in claim 1, wherein the string of characters is defined by a series of user inputs that specify a series of characters in the string and the final character is the character specified by the most recent user input.

7. The method as claimed in claim 1, wherein the graphical symbol having the first visual attribute is part of a composite graphical symbol that corresponds to a plurality of characters.

8. The method as claimed in claim 7, wherein the final character in the string is editable by a user independently of the other characters that correspond to the composite graphical symbol.

9. The method as claimed in claim 7, wherein the composite graphical symbol comprises a graphical symbol corresponding to a consonant character that is extended by the graphical symbol having the first attribute.

10. The method as claimed in claim 9, wherein the graphical symbol corresponding to the consonant character forms a core that is extended by the graphical symbol having the first attribute.

11. The method as claimed in claim 9, wherein the final character in the string is editable independently of the consonant character.

12. The method as claimed in claim 1, wherein the graphical symbol having the first attribute corresponds to a vowel character.

13. The method as claimed in claim 1, wherein the final character in the string is specified by a user input and only the final character in the string has the first attribute.

14. The method as claimed in claim 13, wherein the final character in the string is editable by a user independently of the other characters in the string.

15. The method as claimed in claim 1, wherein the final character in final character in the string is one of a plurality of characters that are automatically generated and the graphical symbols corresponding to the plurality of characters in the string all have the first visual attribute.

16. The method as claimed in claim 1, wherein the first attribute is a first color and the second attribute is a second, different color.

17. (canceled)

18. A memory stored with program instructions which when executed by a processor enables the processor to control the visual attributes of displayed text such that at least a graphical symbol, corresponding to a character in a text string that is adjacent an insertion point, has a first visual attribute that differentiates it from other graphical symbols corresponding to other characters in the text string that have a second visual attribute.

19. An electronic device comprising:
a user input for specifying characters in a string of characters;
a display for displaying the string of characters as text, the text comprising an arrangement of graphical symbols wherein each of the graphical symbols corresponds to a character in the string of characters; and
a processor for controlling the visual attributes of displayed text such that at least a graphical symbol corresponding to a character, adjacent an insertion point, in a string of characters has a first visual attribute that differentiates it from other graphical symbols corresponding to other characters in the string of characters that have a second visual attribute.

20. An electronic device comprising:
means for specifying characters in a string of characters;
means for displaying the string of characters as text, the text comprising an arrangement of graphical symbols wherein each of the graphical symbols corresponds to a character in the string of characters; and
means for controlling the visual attributes of displayed text such that at least a graphical symbol corresponding to a character, adjacent an insertion point, in a string of characters has a first visual attribute that differentiates it from other graphical symbols corresponding to other characters in the string of characters that have a second visual attribute.
